(19) United States
(12) Patent Application Publication
(10) Pub. No.: US 2026/0306357 A1
(43) Pub. Date: Oct. 8, 2026

(54) High-Frequency Abdominal Wall Oscillation (HFAWO) Device for Gastrointestinal Motility Enhancement

(71) Applicant: Mazyar Malakouti, Irving, TX (US)

(72) Inventor: Mazyar Malakouti, Irving, TX (US)

(21) Appl. No.: 19/177,621

(22) Filed: Apr. 13, 2025

Related U.S. Application Data
(60) Provisional application No. 63/784,086, filed on Apr. 5, 2025.

(51) Int. Cl. A61H 23/02

(52) U.S. Cl. CPC A61H 23/0254; A61H 2201/0142; A61H 2201/0173; A61H 2201/1619; A61H 2201/165; A61H 2201/1678; A61H 2201/5005; A61H 2205/083

(57) ABSTRACT

Embodiments of the present invention are medical devices that enhance gastrointestinal function, particularly in hospitalized patients. It uses external high-frequency mechanical oscillation applied to the abdominal wall to promote bowel motility and reduce complications such as post-operative ileus. Embodiments include wearable and bed-integrated devices that apply adjustable oscillatory forces to the abdominal wall to stimulate bowel motility and improve GI transit.

### BACKGROUND

This invention relates to medical devices that enhance gastrointestinal function, particularly in hospitalized patients. It uses external high-frequency mechanical oscillation applied to the abdominal wall to promote bowel motility and reduce complications such as post-operative ileus.

Hospitalized and post-operative patients frequently suffer from impaired GI motility. Current solutions are limited. There is no existing non-invasive oscillatory therapy device for the abdomen.

### SUMMARY OF INVENTION

Therefore, the present invention provides a wearable or bed-integrated device that applies adjustable oscillatory forces to the abdominal wall to stimulate bowel motility and improve GI transit.

### BRIEF DESCRIPTION OF THE DRAWINGS

FIG. 1 illustrates a labeled diagram of the High-Frequency Abdominal Wall Oscillation (HFAWO) Device (Wearable & Bed-Integrated Versions).

FIG. 2 illustrates a step-by-step schematic diagram of the HFAWO device.

FIG. 3 illustrates a detailed schematic of the HFAWO actuator mechanism according to an embodiment.

FIG. 4 illustrates a diagram of a hospital bed-integrated version of the HFAWO system.

FIG. 5 illustrates an electrical and control flow diagram of the HFAWO device.

FIG. 6 illustrates an alternative portable embodiment of the HFAWO device.

### DETAILED DESCRIPTION OF THE DRAWINGS

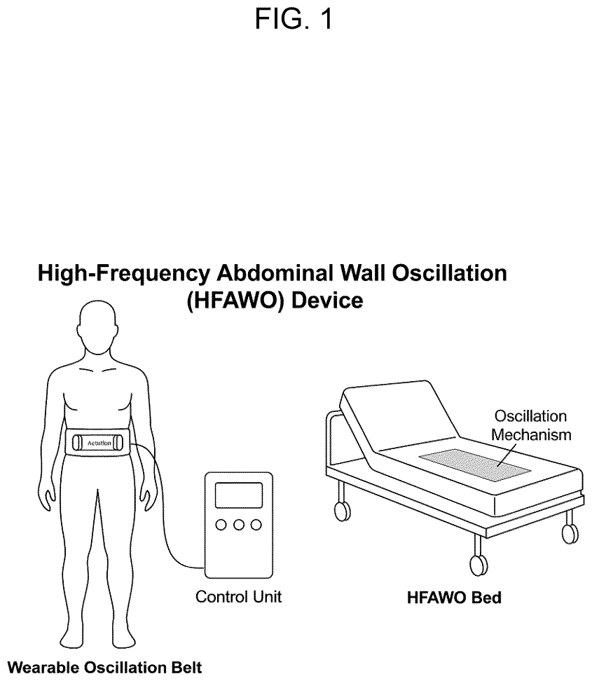

FIG. 1 illustrates a labeled diagram of the High-Frequency Abdominal Wall Oscillation (HFAWO) Device (Wearable & Bed-Integrated Versions).

The components of the device according to embodiments of the present invention include:
1. Oscillatory unit: Mechanical actuators producing adjustable high-frequency vibrations.
2. Contact interface: Padded belt or abdominal panel.
3. Control module: Digital settings for frequency, amplitude, and time.
4. Safety features: Motion sensors, pressure limits, and shut-off timers.

Modes include continuous and pulsed oscillation, peristalsis-mimicking waveforms, and preset programs.

Applications include post-op ileus, bedridden/ICU patients, neurogenic bowel and severe constipation.

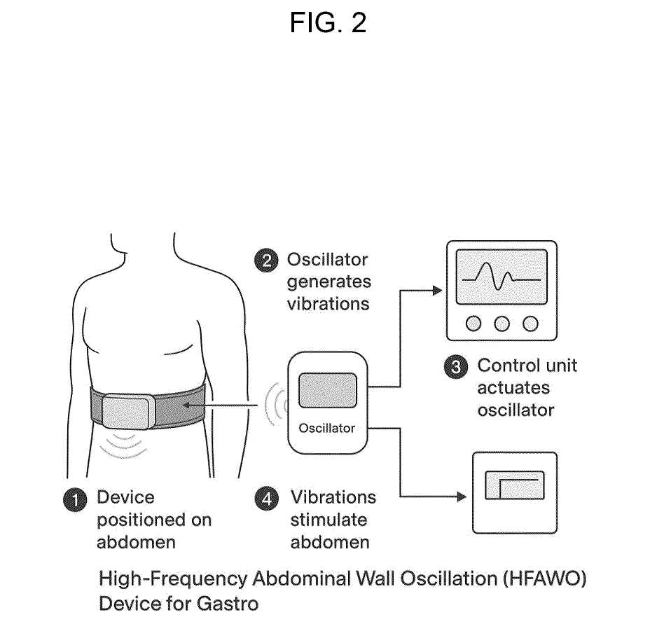

FIG. 2 illustrates a step-by-step schematic diagram of the HFAWO device. The illustration shows the abdominal belt positioned around the patient's midsection, with embedded oscillation components connected to a programmable external control unit. The diagram demonstrates the flow of therapeutic vibration from the control module to the abdomen, with visual indication of oscillatory wave transmission and intended mechanical stimulation of the abdominal wall to enhance gastrointestinal motility.

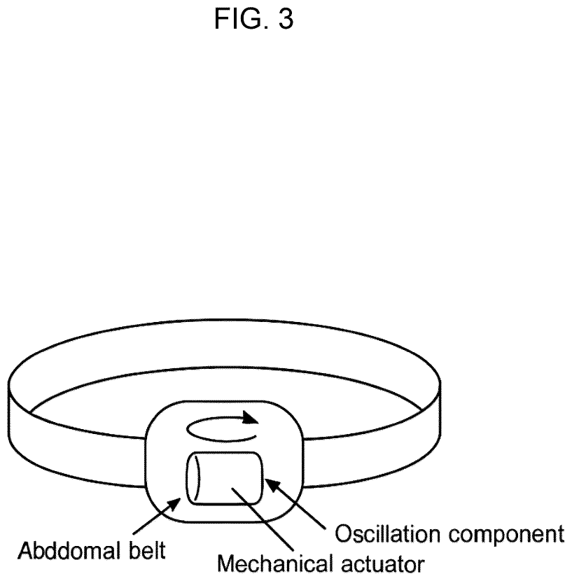

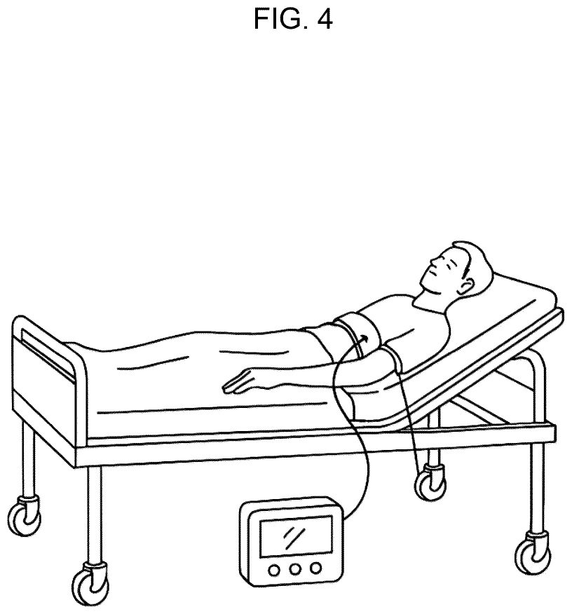

FIG. 3 illustrates a detailed schematic of the HFAWO actuator mechanism embedded within the abdominal belt and FIG. 4 illustrates a diagram of a hospital bed-integrated version of the HFAWO system, showing the external control unit linked to the bed-mounted oscillation system, providing targeted vibration therapy to the abdominal region.

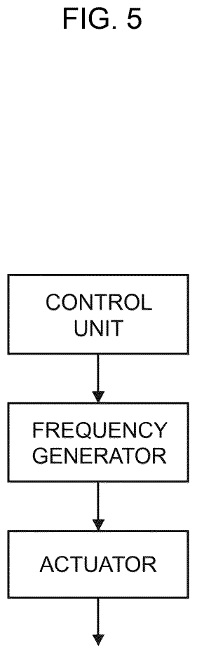

FIG. 5 illustrates an electrical and control flow diagram of the HFAWO device. It illustrates connections between the controller, power source, actuator unit, and abdominal interface.

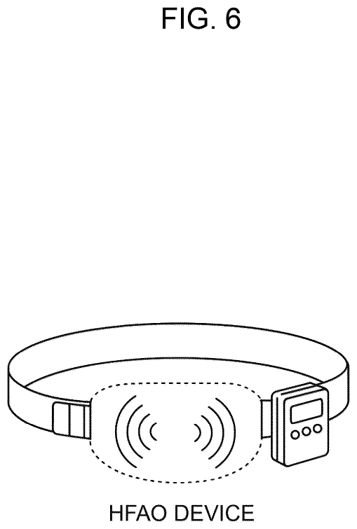

FIG. 6 illustrates an alternative portable embodiment of the HFAWO device. It features a wearable, rechargeable module for home use, designed for outpatient or post-discharge care settings

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A device delivering programmable, high-frequency abdominal oscillations to promote GI motility, comprising:
an oscillatory unit containing mechanical actuators producing adjustable high-frequency vibrations;
a contact interface comprising a padded belt or abdominal panel; and
a control module configured to provide digital settings for frequency, amplitude, and time.

2. The device of claim 1, further comprising one or more safety features selected from the group motion sensors, pressure limits, and shut-off timers.

3. The device of claim 1, wherein the device is integrated with a hospital bed.

4. A method to treat GI dysmotility with oscillatory abdominal therapy, comprising applying the device of claim 1 to the body of a patient and actuating the device.

5. The method of claim 4, wherein the device is applied by surrounding the abdomen of the patient by the belt of the device.

6. The device of claim 1, wherein the device is a wearable, rechargeable module for home use, designed for outpatient or post-discharge care settings.
